(19) United States
(12) Patent Application Publication
(10) Pub. No.: US 2022/0088838 A1
(43) Pub. Date: Mar. 24, 2022

(54) METHOD AND DEVICE FOR HEATING A MOULD

(71) Applicant: ROCTOOL, LE BOURGET DU LAC (FR)

(72) Inventor: JOSÉ FEIGENBLUM, SAINT PAUL (FR)

(21) Appl. No.: 17/543,580

(22) Filed: Dec. 6, 2021

Related U.S. Application Data
(63) Continuation-in-part of application No. 16/098,859, filed on Feb. 19, 2019.

(30) Foreign Application Priority Data
May 10, 2016 (FR) 16 70219

(51) Int. Cl. B29C 35/08; B29C 33/06; B29C 33/04; B29C 33/38

(52) U.S. Cl. CPC B29C 35/0805; B29C 33/06; B29C 2035/0811; B29C 33/38; B29C 33/04

(57) ABSTRACT

A mold to shape a material having a polymer matrix. The mold includes a first and a second die having molding surfaces. The molding surfaces delimit a molding cavity configured to shape the material when the first and the second dies are brought in contact with each other and the mold is closed. The heating plates include a ferromagnetic material configured to be heated by induction, and to transfer heat from a heat transfer surface of the heating plate to a receiving surface of the dies, other than the molding surfaces. The heating plates include heating and cooling channels. The heating channels of the heating plates have an inductor. The cooling channels of the heating plates are configured to circulate a heat transfer fluid.

### RELATED APPLICATIONS

This application is a continuation-in-part of pending U.S. application Ser. No. 16/098,859 filed Feb. 19, 2019, which is a § 371 application from PCT/EP2017/061239 filed May 10, 2017, which claims priority from French Patent Application No. 16 70219 filed May 10, 2016, each of which is herein incorporated by reference in its entirety.

### TECHNICAL FIELD

The invention relates to a method and a device for heating a mold. The invention is more particularly but not exclusively suitable for heating a mold used to shape and consolidate in shape plastic or composite articles. Such a mold comprises a molding cavity inside which the article is shaped. Said cavity is delimited by molding surfaces, the shape of which is reproduced by the shaped part.

Said molding surfaces are supported by a least two shells that can be separated from each other so as to open the mold and remove the solidified part.

The invention applies to various shaping or molding techniques for polymer or fiber reinforced polymer composite parts manufacturing, such as injection molding, hot stamping, plies consolidation in shape or combination thereof such as hot stamping of a composite part followed by an over molding by injection.

### BACKGROUND OF THE INVENTION

A mold adapted to the shaping of a plastic or a composite part comprises a molding cavity delimited by molding surfaces shared between at least two dies, that are brought toward each other when the mold is closed and the part shaped, and set apart from each other to open the mold and remove the shaped part from it.

The cavity is subjected to a thermal cycle during the molding or shaping operation, so that the temperature of the cavity and of the molded part are high enough for the material making the part to be as soft as required to reproduce the shape of the molding cavity.

The temperature is then reduced, if necessary, by forced cooling, so as to solidify the part, until the mold is opened and the part removed from the mold, when the temperature of the molding surfaces reduces before being warmed up again and restarting the cycle. Thus, the cycle time, that is a particularly critical parameter in a large batch production, is dictated by heating and cooling times of the molding cavity.

The quality of the part thus obtained, and in particular its surface finish, depends on the ability to achieve a uniform temperature distribution on the molding surfaces of the cavity.

The structural integrity of the part thus obtained also depends on heating and cooling rates of the molded material in contact with the molding surfaces

The induction heating technique of the molding surfaces has proven to be particularly suitable for providing a solution to these needs, by concentrating the heating on the molding surfaces and avoiding to heat and cool the bulk of the dies.

However, when several part types are made, each requiring a specific dies couple, setting up induction heating means and cooling means for each die couple is costly. Having multiple high power, commonly 100 kW, and high frequency generators to power the induction means for each mold is also costly,

### OBJECT AND SUMMARY OF THE INVENTION

The invention aims at solving the deficiencies of the prior art and to this end pertains to a mold for shaping a material comprising a polymer matrix, comprising:
a first die comprising a first molding surface;
a second die comprising a second molding surface;
the first and the second molding surfaces delimiting a molding cavity adapted to shape the material when the first and the second dies are brought in contact of each other and the mold is closed;
a first heating plate comprising a ferromagnetic material, having a thermal conductivity, adapted to be heated by induction, and to transfer heat from a heat transfer surface of the plate to a receiving surface of the first die, other than the first molding surface;
a second heating plate comprising a ferromagnetic material, having a thermal conductivity, adapted to be heated by induction, and to transfer heat from a heat transfer surface of the plate to a receiving surface of the second die, other than the second molding surface;
the first and the second heating plate comprising a heating and a cooling channel;
wherein the heating channels of the first and the second heating plates comprise an inductor; and
wherein the cooling channels of the first and the second heating plates are adapted to the circulation of a heat transfer fluid.

Therefore, the heat and cool of the dies is performed through the heating plates, said plates being used for a wide variety of dies.

The invention may be implemented according to the embodiments set out below which are to be contemplated individually or according to any technically operative combination.

According to an embodiment, at least one of the first and the second heating plate comprises a heat accumulator heated by the inductor. Thus, after heating the heat accumulator to an appropriate temperature, it is simply held at this temperature, which requires less power.

Advantageously, the heat accumulator comprises a phase changing material. This embodiment makes it possible to store thermal energy in the latent phase change heat of said material.

According to an embodiment the heat transfer surface of the first and the second heating plates comprise a thin strip made of malleable and compressible heat conducting material. Such a strip acts as a shape adaptation layer at the interface between the receiving surface of the die and the heat transfer surface of the plate or of the heat accumulator, reducing the thermal resistance of the contact and promoting heat transfer.

Advantageously the dies are made of a material having a higher thermal conductivity than the heating plates, preferably 2 to 3 times higher. Example of such materials when the heating plates are made of a ferromagnetic steel are aluminum alloys, copper alloys, graphite or nickel without this list being limiting. The high thermal conductivity and thermal diffusivity of the material making the dies promotes rapid heating and quick homogenization of the temperatures on the molding surfaces.

According to an embodiment, the dies comprise cooling channels for the circulation of a heat transfer fluid. This allows to cool the dies quicker after a molding or shaping cycle and to reduce cycle times.

According to an embodiment, the heat accumulator is a block made of a heat expandable material, that when heated contacts the receiving surface of the die by way of its thermal expansion.

In a variant of this last embodiment, the receiving surface of a die and the heat transfer surface of a heat accumulator are of complementary profiles.

### BRIEF DESCRIPTION OF THE DRAWINGS

The invention is described below in its preferred embodiments, that are in no way limitative, with reference to FIGS. 1 to 4, wherein:

FIG. 1 is an exploded view in perspective of an exemplary embodiment of the mold of the invention;

FIG. 2 is a partial view in perspective of the mold of FIG. 1, according to AA cross-section defined in FIG. 1;

FIG. 3A is a side partial view of another embodiment of the mold of the invention according to a cross-section equivalent to AA;

FIG. 3B is the same view as FIG. 3A showing the state of the heat accumulator when the latter is heated;

FIG. 4A shows a side partial view of still another embodiment of the mold of the invention according to a cross-section equivalent to AA; and

FIG. 4B is the same view as FIG. 4A showing the state of the heat accumulator when the latter is heated.

### DETAILED DESCRIPTION OF THE EMBODIMENTS

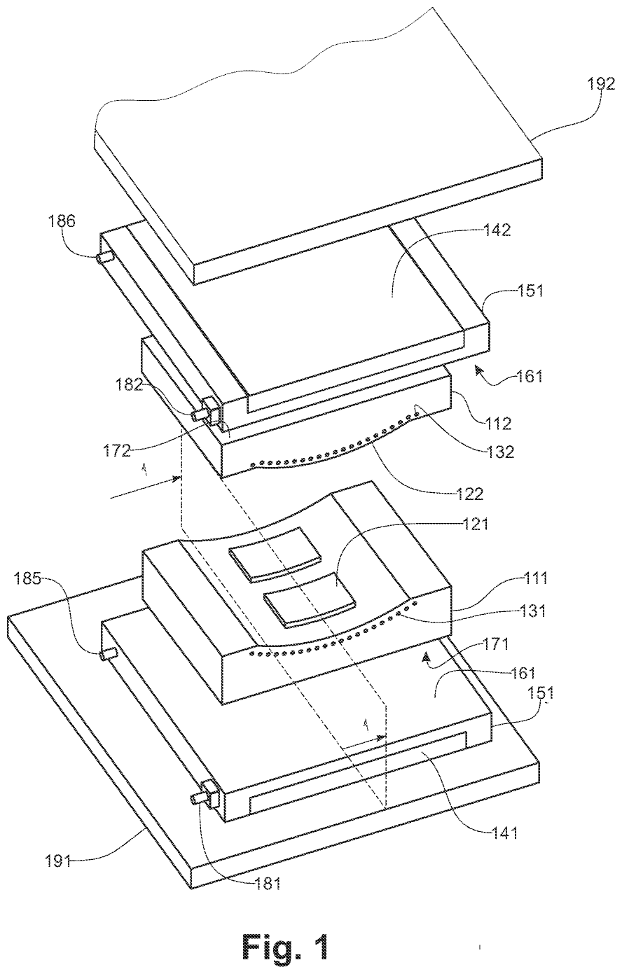

FIG. 1, according to an exemplary embodiment the mold of the invention comprises 2 dies (111, 112), each die comprises one or more molding surfaces (121, 122) the shape of which is reproduced by the part being formed, the molding surfaces of both dies forming a cavity when the two dies are brought in contact to one another, that is, when the mold is closed.

Such a pair for dies may be used for various shaping or molding operations like stamping, consolidation in shape, injection molding or combination thereof without these examples being limiting.

In a stamping, operation a flat blank made of a composite material comprising reinforcing fibers in a thermoplastic polymer matrix is placed on a first die (111). The temperature of the blank is raised to a level where the polymer reaches a pasty state, as for instance by heating the first die, the second die (112) is moved towards the first die, thus closing the mold and urging the flat blank to the shape of the cavity. The temperature is then lowered to a level where the polymer is rigid enough before opening the mold and removing the part.

During a consolidation in shape operation, fibrous plies pre-impregnated with a thermoplastic polymer are laid up on the molding surface (121) of a first cold die (111) to make a preform. The mold is closed so that the preform is contained in the cavity delimited by the molding surfaces (121, 122) of the two dies, the temperature inside de cavity is raised to a level where the polymer melts and impregnates all the plies, while maintaining the closure pressure. The temperature is then lowered to consolidate the assembly, the mold is opened, and the part removed.

During an injection molding operation, the mold is closed, the cavity is heated to a suitable temperature, a polymeric material in a pasty, comprising or not a reinforcement phase, is injected in the cavity so as to fill up said cavity. The temperature of the cavity is then lowered to a level where the plastic materiel solidifies, the mold is opened, and the molded part removed.

Such a mold is also suitable for curing thermosets composite prepregs with a similar method to the one exposed in the case of the consolidation in shape.

Each die is assembled by suitable means on a heating plate (151, 152), said heating plates being secured on press platens (191, 192), the press being used to close and open the mold.

A heating plate comprises a heating surface (161, 162) being adapted to transfer heat to the die through a receiving surface (171, 172) of the die, different from the molding surface. According to the shown embodiment, the receiving surface is located on a face of the die opposite the molding surface (121, 122).

The heat transfer from the heating surface (161, 162) of the heating plate to the receiving surface (171, 172) of the die may be performed by radiation, conduction, by forced convection of a fluid or combination thereof.

According to this exemplary embodiment each heating plate further comprises a thermal accumulator (141, 142).

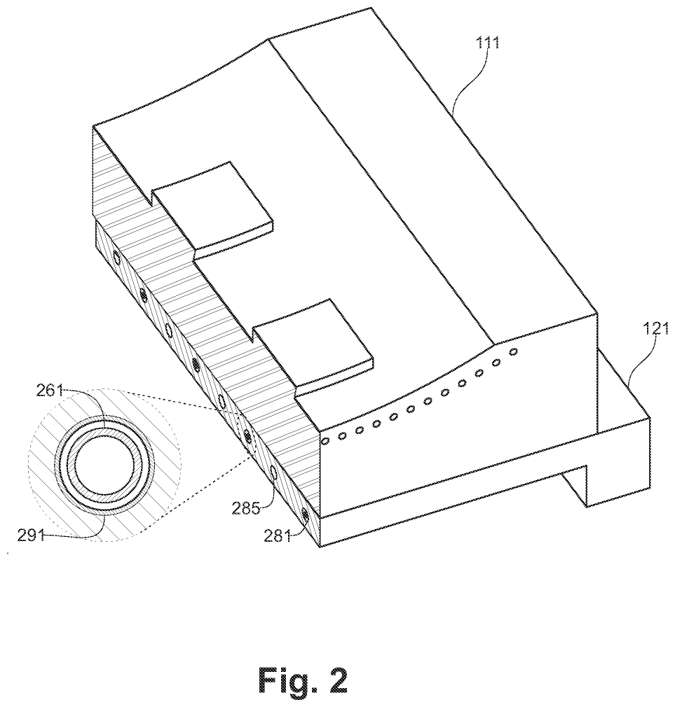

The heating plates comprise heating and cooling means as shown on FIG. 2, and means (181, 182, 185, 186) to connect those means to a heating and a cooling source.

In a preferred embodiment, the dies comprise cooling means in the form of channels (131, 132) adapted for the circulation of a heat transfer fluid, close to the molding surfaces.

The heating means of the heating plates are connected through the adapted connection (181, 182) to a high frequency generator.

The dies are made of a good heat conducting material, preferably a metallic material, and preferably an aluminum alloy.

FIG. 2, according to an exemplary embodiment a heating plate comprises channels (281, 285). A first set of channels (281) comprises an inductor (261) connected to a high frequency generator (not shown).

As an exemplary implementation the inductor is a tube made of copper or a copper alloy. According to another implementation the inductor is made of multi-strand Litz wires.

According to an exemplary embodiment, the heating plate (111) is made of a ferromagnetic material that is heated by induction when a high frequency electric current circulates in the inductor (261).

According to another embodiment the heating plate is made of a paramagnetic or a nonmagnetic material exhibiting a good thermal conductivity such as a copper alloy and the channels (281) receiving the inductor (261) are coated with a layer (291) of a ferromagnetic material adapted to be induction heated when a high frequency alternative electric current circulates in the inductor (261).

Returning to FIG. 1, the heat accumulator (141, 142) is here comprised between the heating plate and the press platen (191, 192) and does not contact the die (111, 112). In this embodiment the heat accumulator is for example made of a refractory material such as a ceramic or chamotte with an alumina content ranging from 30% to 80%.

The refractory heat accumulator also protects the press platens from high temperature exposition.

When the inductors of the heating plates are supplied in high frequency alternative current they heat up said heating plates that transfer their heat to both the dies (111, 112) and the heat accumulators (141, 142).

Because the thermal inertia of the heat accumulator is much higher than the ones of the heating plates and the dies, and advantageously because the dies comprise cooling channels (131, 132) close to the molding surfaces, once the heat accumulator reaches a steady temperature less electric energy is required to reheat the dies from one shaping cycle to another.

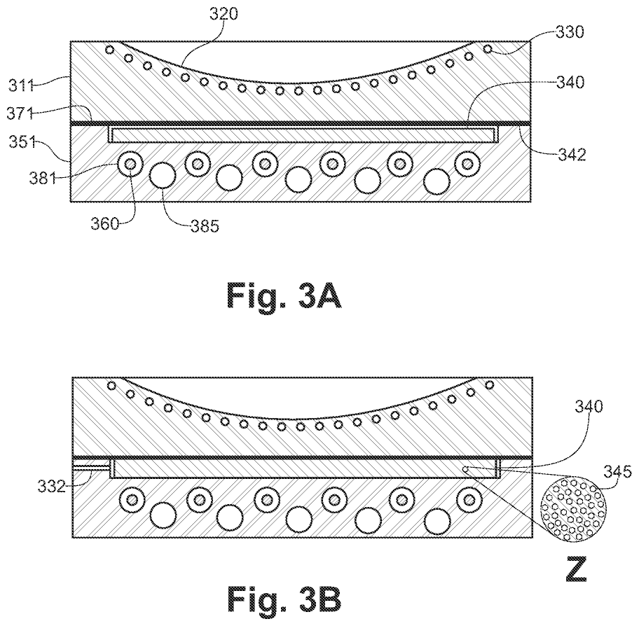

FIG. 3A, according to another embodiment of a mold according to the invention, the heat accumulator (340) is set up between the heating plate (321) and the die (311).

The heating plate (321) comprises heating channels (381) in which inductors (360) making an induction circuit extend.

According to one particular embodiment, the heating plate is made of a nonmetallic refractory material, for example a ceramic or a concrete, transparent to the magnetic field. Therefore, according to the latter embodiment the bulk of the heating plate is not heated when the induction circuit is energized with a high frequency alternative current, and does not require cooling.

Alternatively, the heating plate is made of a nonmagnetic metallic material, in this case the heating plate is further thermally insulated from the press platen and comprises cooling channels (385) for the circulation of a heat transfer fluid.

A heat accumulator (340) is inserted between the heating plate (321) and the die (311). Said heat accumulator is for example made of a ferromagnetic steel with a high Curie point, for example an alloy based on iron (Fe) and silicon (Si) or iron (Fe) and cobalt (Co). It is preferably thermally isolated from the heating plate (321).

When the inductors (360) are supplied with a high frequency alternative current, the accumulator is thus subjected to induction heating.

The accumulator does not come into contact with the receiving surface (371) of the die (311) until it reaches a given temperature. In such a condition the contact resistance between the accumulator (340) and the receiving surface (371) is high and heat transfer between the heat accumulator (340) and the die carrying the die cavity (320) is low, being essentially made by radiation.

Therefore, the inductor (360) may be energized at a reduced power, keeping the accumulator at a given temperature while not heating the die (311).

FIG. 3B, when the power supplied to the inductor (360) is increased the temperature of the heat accumulator raises, leading to the thermal expansion of the heat accumulator (340) that comes into intimate contact with the receiving surface (371). The contact resistance drops, and the heat accumulator transmits its heat to the die (311) by conduction, said heat is conducted to the molding surface (320).

Advantageously, the receiving surface (371) of the die comprises an interface layer (342), consisting in a thin sheet made of a malleable and compressible heat conducting material, soldered or welded onto the receiving surface.

As non-limitative examples, said sheet is made of copper or of a copper alloy, or may also be made of a crushable material like graphite.

Thus, when the heat accumulator (340) contacts the sheet (342), the sheet deforms so as to compensate for the small shape differences between the heat accumulator and the receiving surface, and provides optimal heat transfer between the two.

As a for instance, the heat accumulator is held at a holding temperature of about 50° C. to 100° C. below the temperature required for the shaping of the material. Holding this temperature requires the use of lower electrical power.

When the shaping of the part requires a higher temperature, the power supplied to the inductor is increased but reduced as compared to the situation of where both the die and the heating plate are cold since the heat accumulator is already at a temperature close to the temperature required for the shaping of the material.

The heat accumulator (340) does not perform any structural function in the mold. Its composition is thus chosen to optimize its response to induction heating and its ability to transfer its heat to the die (311) and then to the molding surface.

According to a particular embodiment, detail Z, said accumulator has a cellular structure, each cell (345) being filled with a phase changing material with a latent heat of transition. Advantageously, the phase changing material is chosen such that its transition temperature is close to the holding temperature of the heat accumulator. The porous material may be, for example, a copper wires mat or mesh.

For example, if the holding temperature is of the order of 200° C., the phase changing material may be an organic material such as a polyol.

If the holding temperature is higher, for example of the order of 400° C. or more, the phase changing material may be a salt.

According to these examples, the phase changing material changes phase from the solid state at low temperature to the liquid state at a higher temperature, absorbing latent heat of transition. In changing from the high temperature phase to the low temperature phase, the phase changing material solidifies and restores said latent heat of transition. The combination of the cellular structure and the presence of a phase changing material can increase the apparent thermal inertia of the heat accumulator (340) while holding it at the holding temperature, while maintaining a capability of fast heating up to the heating temperature.

The die cavity is cooled by circulation of the heat transfer fluid in the channels (330) made in the die (311) close to the molding surface.

When the heating plate is made of a metallic material that is not subject to induction heating a heat transfer fluid may circulate in the cooling channels (385) of the heating plate at all time, event during the heating phase when the heat accumulator comes into contact with the die.

In a specific embodiment the heating plate comprises channels (332) for conveyance of a heat transfer fluid around the heat accumulator (340) so as to accelerate its cooling to its holding temperature after the heating and temperature holding phase of the die molding surface (320).

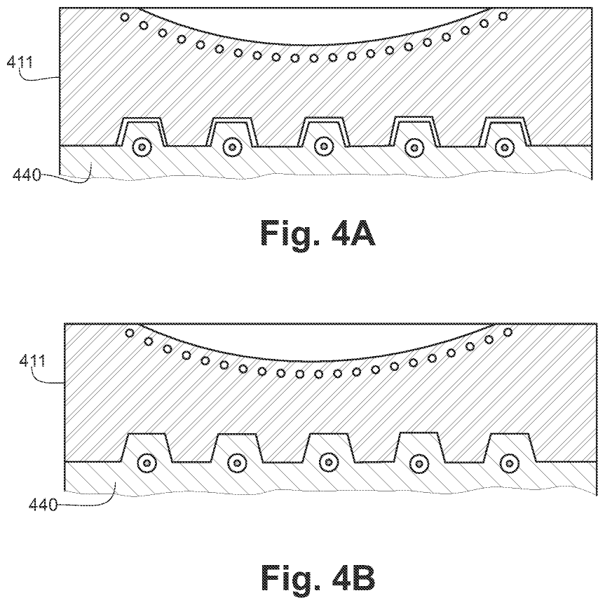

FIG. 4A, according to a further embodiment the interface between the die (411) and the heating plate or with the heat accumulator (440) is not plane but has complementary profiles.

This embodiment enables to increase the potential contact surface between the die (411) and the heating plate or the heat accumulator (440).

Outside the heating period of the die (411), the two profiles are discontinuous at the receiving surface.

FIG. 4B, in the heating phase, the thermal expansion of the heat accumulator (440) due to its temperature rise brings its profile into contact with the receiving surface of the die (411) thus reducing the thermal contact resistance between the two and enabling the heat transfer by conduction.

The above description and exemplary embodiments show that the invention achieves its aims, making it possible to benefit from the advantages of induction heating to heat the molding cavity of a mold, made of a non-ferromagnetic material, for example an aluminum alloy, while reducing the manufacturing cost of the mold and the power demand required for this heating and thus maintaining reasonable sizing of the electrical power supply circuit.

The mold of the invention is adapted to different kind of shaping operations such as hot stamping, consolidation or curing in shape or injection molding.

1. A mold for shaping a material comprising a polymer matrix, comprising:
a first die comprising a first molding surface;
a second die comprising a second molding surface;
wherein the first and the second molding surfaces delimit a molding cavity configured to shape the material when the first and the second dies are brought in contact with each other and the mold is closed;
a first heating plate comprising a ferromagnetic material, having a thermal conductivity, configured to be heated by induction, and to transfer heat from a heat transfer surface of the first heating plate to a receiving surface of the first die, other than the first molding surface;
a second heating plate comprising a ferromagnetic material, having a thermal conductivity, configured to be heated by induction, and to transfer heat from a heat transfer surface of the second heating plate to a receiving surface of the second die, other than the second molding surface; and
wherein each of the first and the second heating plate comprising a heating channel and a cooling channel, the heating channels of the first and the second heating plates comprise an inductor, and the cooling channels of the first and the second heating plates are configured to circulate a heat transfer fluid.

2. The mold of claim 1, wherein at least one of the first and the second heating plate comprises a heat accumulator heated by the inductor.

3. The mold of claim 2, wherein the heat accumulator comprises a phase changing material.

4. The mold of claim 1, wherein the heat transfer surfaces of the first and the second heating plates comprise a thin strip made of malleable and compressible heat conducting material.

5. The mold of claim 1, wherein the first and second dies are made of an aluminum alloy.

6. The mold of claim 1, wherein the first and second dies are made of an aluminum alloy.

7. The mold of claim 1, wherein the first and second dies are made of a material having a thermal conductivity 2 or 3 times higher than a thermal conductivity of a material of the heating plates.

8. The mold of claim 1, wherein the first and second dies comprise cooling channels to circulate the heat transfer fluid.

9. The mold of claim 8, wherein the heat accumulator is a block made of a heat expandable material, the heat accumulator contacts the receiving surface of a corresponding die when heated by a thermal expansion of the heat accumulator.

10. The mold of claim 9, wherein the receiving surface of the corresponding die and a heat transfer surface of the heat accumulator are of complementary profiles.
